(19) United States
(12) Patent Application Publication
(10) Pub. No.: US 2013/0074048 A1
(43) Pub. Date: Mar. 21, 2013

(54) SYSTEM, INFORMATION PROCESSING APPARATUS AND CONTROL METHOD THEREOF, IMAGE FORMING APPARATUS AND CONTROL METHOD THEREOF, AND COMPUTER-READABLE MEDIUM

(71) Applicants: Takaharu Osawa, Yokohama-shi (JP); Yusuke Fukasawa, Tokyo (JP)

(72) Inventors: Takaharu Osawa, Yokohama-shi (JP); Yusuke Fukasawa, Tokyo (JP)

(73) Assignee: CANON KABUSHIKI KAISHA, Tokyo (JP)

(21) Appl. No.: 13/588,157

(22) Filed: Aug. 17, 2012

(30) Foreign Application Priority Data
Sep. 21, 2011 (JP) 2011-206559

(51) Int. Cl. G06F 9/44

(52) U.S. Cl. 717/127

(57) ABSTRACT

An information processing apparatus which provides a development environment for an application to be executed by an image forming apparatus, comprises: a unit that generates, upon receiving an instruction to generate an application to be executed in the image forming apparatus, an application containing an application program for implementing a function of the application, a test program for testing a function provided by the application, and a test agent program for issuing a command to start execution of the test program in accordance with an instruction from the information processing apparatus; and a unit that issues, upon receiving an instruction to start the test program, an instruction via the test agent program to start execution of the test program contained in the application installed in the image forming apparatus.

### BACKGROUND OF THE INVENTION

1. Field of the Invention

The present invention relates to a system which executes a unit test for an application in an image forming apparatus capable of installing an application, an information processing apparatus and control method thereof, an image forming apparatus and control method thereof, and a computer-readable medium.

2. Description of the Related Art

Conventionally in an image forming apparatus and its control, an execution environment (for example, Java®) for another embedded system can be built on a real-time OS. Further, an application platform capable of externally downloading and adding an application for controlling an image forming apparatus has been mounted.

There is provided a development environment used when developing an application on the application platform. For example, Japanese Patent Laid-Open No. 2009-519544 discloses a mechanism of automatically performing build up to acquisition of a test result, storing the state of an application platform, and facilitating debugging.

To check the operation of a developed application, another test application is generated. The generated application calls the API (Application Program Interface) of the developed application and checks the operation. In this case, by using a function provided by the framework of a platform on which the application runs, the application to be tested needs to permit publication of an API in advance so that the API is called from another application (outside).

More specifically, a setting file in the application needs to make an export declaration for publication. The application which performs a test needs to be implemented so that it can use a publicized API. On the premise of an export declaration in a manifest file serving as the setting file of an API, the application needs to make an import declaration for the API. To check the operation of a developed application using two applications, both of the applications require implementations for executing a test.

The method of checking the operation of an application using a test application is effective for debugging during application development. However, commercially available applications are configured so that an API is not called from the outside in terms of security. As for an API which does not require an export declaration, no export declaration is made in the manifest file. Hence, this method cannot be used as a method of, when a problem occurs in the market (environment of a user who purchased the application), checking the operation of the application in the user environment.

Also, when an export declaration is temporarily made in the manifest file for debugging in application development, the developer may forget to return the change to an original state. In this case, the application can be called from the outside. If the application in this state comes onto the market, a malicious user may attack the application. This poses a security problem.

### SUMMARY OF THE INVENTION

According to one aspect of the present invention, there is provided a system comprising an image forming apparatus capable of installing and executing a provided application, and an information processing apparatus which provides a development environment for the application to be executed by the image forming apparatus, the information processing apparatus including: a generation unit configured to generate, upon receiving an instruction to generate an application to be executed in the image forming apparatus, an application containing an application program for implementing a function of the application, a test program for testing a function provided by the application, and a test agent program for issuing a command to start execution of the test program in accordance with an instruction from the information processing apparatus; a send unit configured to send the application generated by the generation unit to the image forming apparatus; and an instruction unit configured to issue, upon receiving an instruction to start the test program, an instruction via the test agent program to start execution of the test program contained in the application installed in the image forming apparatus, and the image forming apparatus including: an installation unit configured to install the application upon receiving an instruction to install the application generated by the generation unit; and a start unit configured to start execution of the test program in accordance with the command issued from the test agent program upon accepting the instruction from the instruction unit via the test agent program to start execution of the test program.

According to another aspect of the present invention, there is provided an image forming apparatus capable of installing and executing an externally provided application, comprising: a reception unit configured to receive an application containing an application program for implementing a function of the application, a test program for testing a function provided by the application, and a test agent program for issuing a command to start execution of the test program in accordance with an external instruction; an installation unit configured to install the received application; and a start unit configured to start execution of the test program in accordance with the command issued from the test agent program upon accepting the instruction via the test agent program to start execution of the test program.

According to another aspect of the present invention, there is provided an information processing apparatus which provides a development environment for an application to be executed by an image forming apparatus capable of adding and executing an externally provided application, comprising: a generation unit configured to generate, upon receiving an instruction to generate an application to be executed in the image forming apparatus, an application containing an application program for implementing a function of the application, a test program for testing a function provided by the application, and a test agent program for issuing a command to start execution of the test program in accordance with an instruction from the information processing apparatus; a send unit configured to send the application generated by the generation unit to the image forming apparatus; and an instruction unit configured to issue, upon receiving an instruction to start the test program, an instruction via the test agent program to start execution of the test program contained in the application installed in the image forming apparatus.

According to another aspect of the present invention, there is provided a method of controlling an image forming apparatus capable of installing and executing an externally provided application, comprising the steps of: receiving an application containing an application program for implementing a function of the application, a test program for testing a function provided by the application, and a test agent program for issuing a command to start execution of the test program in accordance with an external instruction; installing the received application; and starting execution of the test program in accordance with the command issued from the test agent program upon accepting the instruction via the test agent program to start execution of the test program.

According to another aspect of the present invention, there is provided a method of controlling an information processing apparatus which provides a development environment for an application to be executed by an image forming apparatus capable of adding and executing an externally provided application, comprising the steps of: generating, upon receiving an instruction to generate an application to be executed in the image forming apparatus, an application containing an application program for implementing a function of the application, a test program for testing a function provided by the application, and a test agent program for issuing a command to start execution of the test program in accordance with an instruction from the information processing apparatus; sending the application generated in the generation step to the image forming apparatus; and issuing, upon receiving an instruction to start the test program, an instruction via the test agent program to start execution of the test program contained in the application installed in the image forming apparatus.

According to another aspect of the present invention, there is provided a non-transitory computer-readable medium storing a program for causing a computer to function as a reception unit configured to receive an application containing an application program for implementing a function of the application, a test program for testing a function provided by the application, and a test agent program for issuing a command to start execution of the test program in accordance with an instruction from the computer, an installation unit configured to install the received application, and a start unit configured to start execution of the test program in accordance with the command issued from the test agent program upon accepting the instruction via the test agent program to start execution of the test program.

According to another aspect of the present invention, there is provided a non-transitory computer-readable medium storing a program for causing a computer to function as a generation unit configured to generate, upon receiving an instruction to generate an application to be executed in an image forming apparatus capable of adding and executing an externally provided application, an application containing an application program for implementing a function of the application, a test program for testing a function provided by the application, and a test agent program for issuing a command to start execution of the test program in accordance with an external instruction, a send unit configured to send the application generated by the generation unit to the image forming apparatus, and an instruction unit configured to issue, upon receiving an instruction to start the test program, an instruction via the test agent program to start execution of the test program contained in the application installed in the image forming apparatus.

According to the present invention, an application contains a bundle used for a unit test. An externally installed unit test bundle can be called without changing the settings of the application. Further, an operation check test for the application can be executed even in an environment where it is difficult to alter the application, such as the environment of a user who purchased the application.

Further features of the present invention will become apparent from the following description of exemplary embodiments (with reference to the attached drawings).

### BRIEF DESCRIPTION OF THE DRAWINGS

FIG. 1 is a block diagram exemplifying the internal arrangement of an image forming apparatus;

FIG. 2 is a block diagram exemplifying the software structure of the image forming apparatus;

FIG. 3 is a block diagram exemplifying the hardware arrangement of a development PC connected to the image forming apparatus;

FIG. 4 is a block diagram exemplifying the software arrangement of an integrated development system;

FIG. 5 is a block diagram exemplifying the software arrangement of the image forming apparatus when performing a test;

FIG. 6 is a block diagram exemplifying the more detailed software arrangement of a generation unit;

FIG. 7 is a block diagram exemplifying the software arrangement of a test broker;

FIG. 8 is a block diagram exemplifying the arrangement of a test application;

FIGS. 9A, 9B, 9C, and 9D are views each exemplifying the UI of the integrated development system;

FIGS. 10A and 10B are a flowchart and view, respectively, showing generation of a test case project;

FIG. 11 is a flowchart showing processing when generating a test application;

FIG. 12 is a flowchart showing installation of a test application;

FIGS. 13A and 13B are views each exemplifying a UI for installing a test application;

FIG. 14 is a flowchart showing execution of the test case of a test application;

FIG. 15 is a flowchart showing a communication sequence to execute a test case and send the test result;

FIG. 16 is a flowchart showing a sequence to execute a test;

FIG. 17 is a view exemplifying a test case which is divided for respective models of image forming apparatuses;

FIG. 18 is a table exemplifying the package name of a divided test case according to the second embodiment; and

FIG. 19 is a flowchart showing execution of a divided test case by an agent.

### DESCRIPTION OF THE EMBODIMENTS

Embodiments of the present invention will now be described in detail with reference to the accompanying drawings. It is to be understood that the following embodiments are not intended to limit inventions regarding the appended claims, and that not all combinations of features described in the embodiments are indispensable for the means to solve the problems in the present invention.

### First Embodiment

[Hardware Arrangement of Image Forming Apparatus]

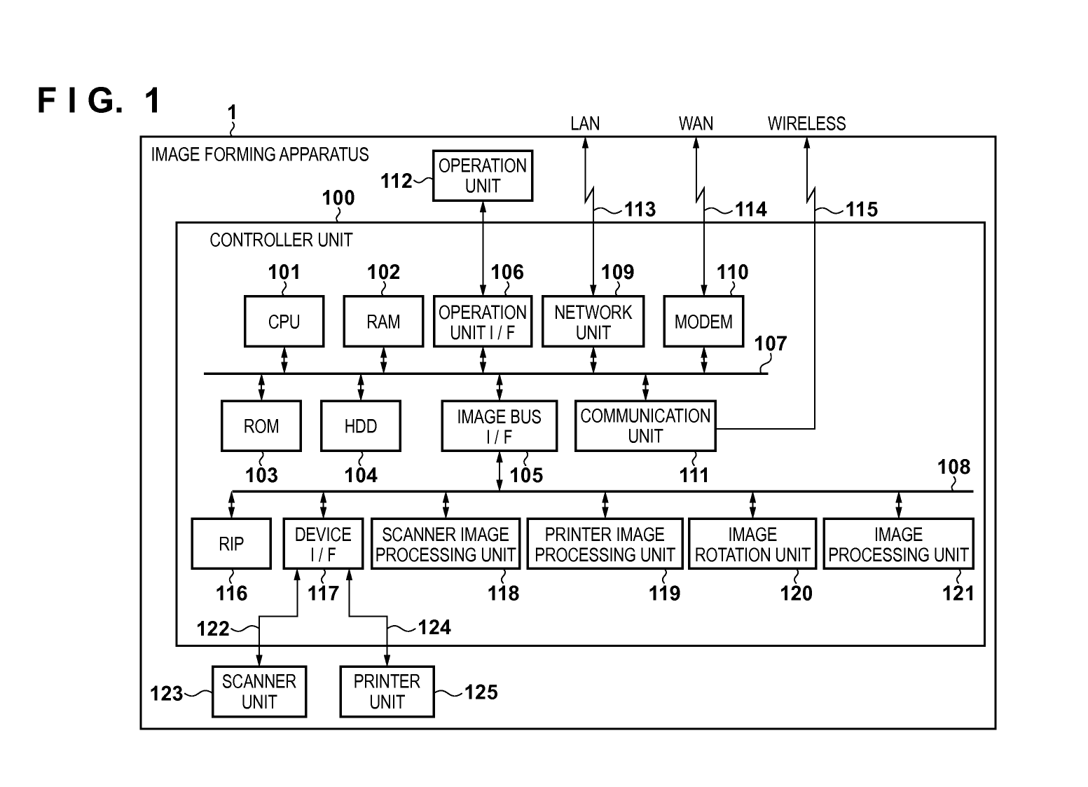

The first embodiment of the present invention will be described in detail below with reference to the accompanying drawings. FIG. 1 is a block diagram exemplifying the internal arrangement of the image forming apparatus according to the embodiment of the present invention.

An image forming apparatus 1 shown in FIG. 1 includes, as basic components, a controller unit 100 which controls respective units in the image forming apparatus 1, an operation unit 112, a scanner unit 123, and a printer unit 125. The operation unit 112 is formed from hard keys such as a ten-key pad for inputting a numeral and a start key for executing processing, and a liquid crystal touch panel. The operation unit 112 provides a user interface for operating the image forming apparatus 1 by the user. By touching (pressing) icons and buttons (or hard keys) which are displayed on the touch panel of the operation unit 112 and represent respective setting items, the user can input settings and information to the image forming apparatus 1.

The scanner unit 123 scans the image of a document or the like as image data. The printer unit 125 conveys printing paper, and prints the image data as a visible image on the printing paper.

The controller unit 100 is connected to the scanner unit 123 via a bus 122, and the printer unit 125 via a bus 124. The controller unit 100 is also connected to another device via a LAN 113, public line (WAN) 114, or wireless channel 115, and performs input/output control of image information and device information.

A CPU 101 is a controller which controls the overall system. A RAM 102 is a system work memory for operating the CPU 101, and is also an image memory for temporarily storing image data. A ROM 103 is a boot ROM. The ROM 103 stores the boot program of the system. An HDD 104 is a hard disk drive which stores system software, image data, and information (wireless communication specifications) about all wireless communications supported by a communication unit 111 (to be described later).

The image forming apparatus 1 can add a function by installing an application which implements a function to be used. Upon installing an application, the RAM 102 or HDD 104 stores an application program for operating various functions on the image forming apparatus.

An operation unit I/F 106 is an interface with the operation unit 112 serving as a user interface (UI). The operation unit I/F 106 outputs data to be displayed on the operation unit 112 to the operation unit 112. Also, the operation unit I/F 106 transmits information which has been input by the user via the operation unit 112 to the CPU 101. A network unit 109 is connected to the LAN 113, and inputs/outputs information. A MODEM 110 is connected to the public line 114, and inputs/outputs information.

The communication unit 111 is connected to the wireless channel (WIRELESS) 115 via an antenna (not shown), and inputs/outputs information. The communication unit 111 can perform a plurality of types of wireless communications. These devices are arranged on a system bus 107.

An image bus I/F 105 is a bus bridge which connects the system bus 107 and an image bus 108 for transferring image data at high speed, and converts the data structure. The image bus 108 is a PCI bus or a bus defined by IEEE1394 or the like.

Of devices arranged on the image bus 108, a raster image processor (RIP) 116 rasterizes a PDL code into a bitmap image. A device I/F 117 connects the scanner unit 123 or printer unit 125 to the controller unit 100, and performs synchronous/asynchronous conversion of image data.

A scanner image processing unit 118 corrects, processes, or edits input image data. A printer image processing unit 119 executes correction, resolution conversion, and the like complying with the printer unit 125 for printout image data. An image rotation unit 120 rotates image data. An image processing unit 121 performs, for image data, compression/decompression processing based on JPEG, JBIG, MMR, or MH, and format conversion processing based on PDF, TIFF, OCR, or encryption.

[Software Arrangement of Image Forming Apparatus]

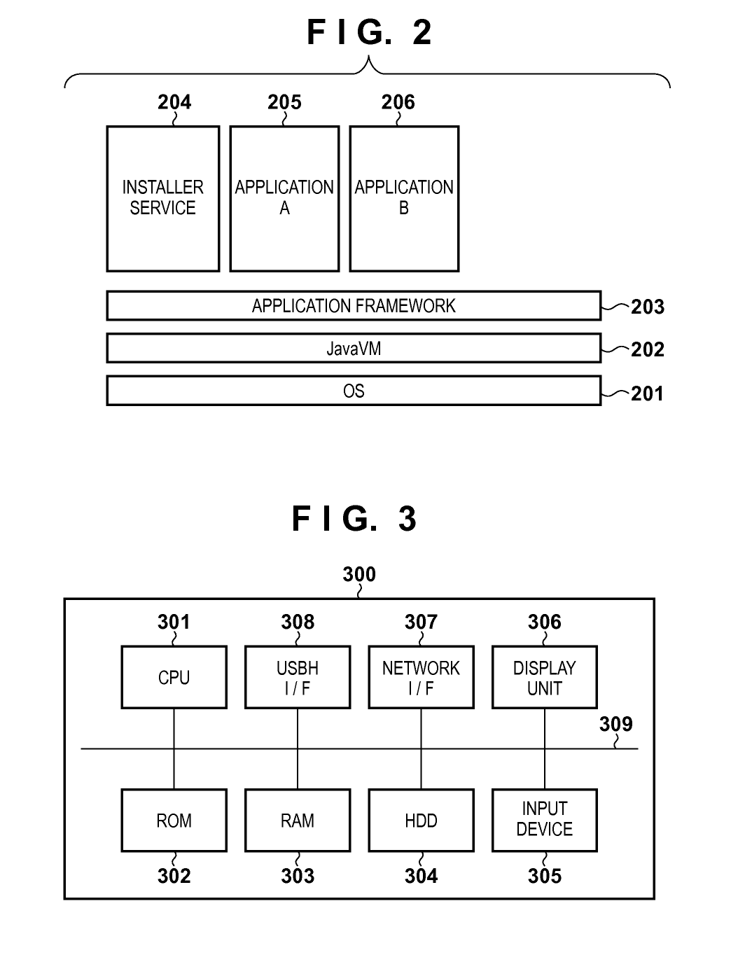

FIG. 2 is a block diagram showing the structure of software stored in the HDD 104 of the image forming apparatus 1 as an example of the image forming apparatus according to the present invention. The CPU 101 executes these programs, implementing various functions.

An OS (Operating System) 201 is a general real-time OS. As the OS, a general-purpose OS such as Linux® is also available. A Java VM 202 is a virtual machine typified by Java®, and provides an application execution environment. Note that the virtual machine is not limited to this. An application framework 203 provides a function of managing the lifecycle of an application. An installer service 204 performs install processing by registering a plurality of applications such as an application A 205 and application B 206 in the application framework 203.

The application A 205 and application B 206 are applications which have been installed by the installer service 204 and provide various functions on the image forming apparatus 1. The application A 205 and application B 206 can exchange information with the user via the operation unit 112 using an I/F (not shown). The application A 205 and application B 206 can also receive data from a PC or the like via the network unit 109, and print it using the printer unit 125. Note that the installer service 204 is accessed from a PC using a browser, and receives a predetermined application file.

[Hardware Arrangement of PC]

FIG. 3 is a block diagram showing the hardware arrangement of a development PC 300 serving as an information processing apparatus connected to the image forming apparatus 1 via a network. When developing an application for the image forming apparatus, an integrated development environment generally runs on the development PC 300 to, for example, generate, test, and debug a program. When testing an application, the application is installed from the development PC 300 into the image forming apparatus 1 via the network unit 109, operated on the image forming apparatus 1, and tested.

A CPU 301 is a central processing unit which manages respective processes on the development PC 300. A ROM 302 stores programs and data regarding respective processes in the development PC 300. A RAM 303 stores temporary data regarding respective processes in the development PC 300. An HDD 304 stores programs and data regarding respective processes in the development PC 300, temporary data, and program modules according to the present invention. An input device 305 includes a keyboard and pointing device which accept instruction inputs to the development PC 300. A display unit 306 displays the operation state of the development PC 300, and information output from each program running on the development PC 300. A network I/F 307 is connected to a LAN and the Internet via a network, and exchanges information with the outside. A USBH I/F 308 is a USB host interface which connects various USB devices. These elements are connected by a system bus 309, send/receive data.

[Software Arrangement in Integrated Development System]

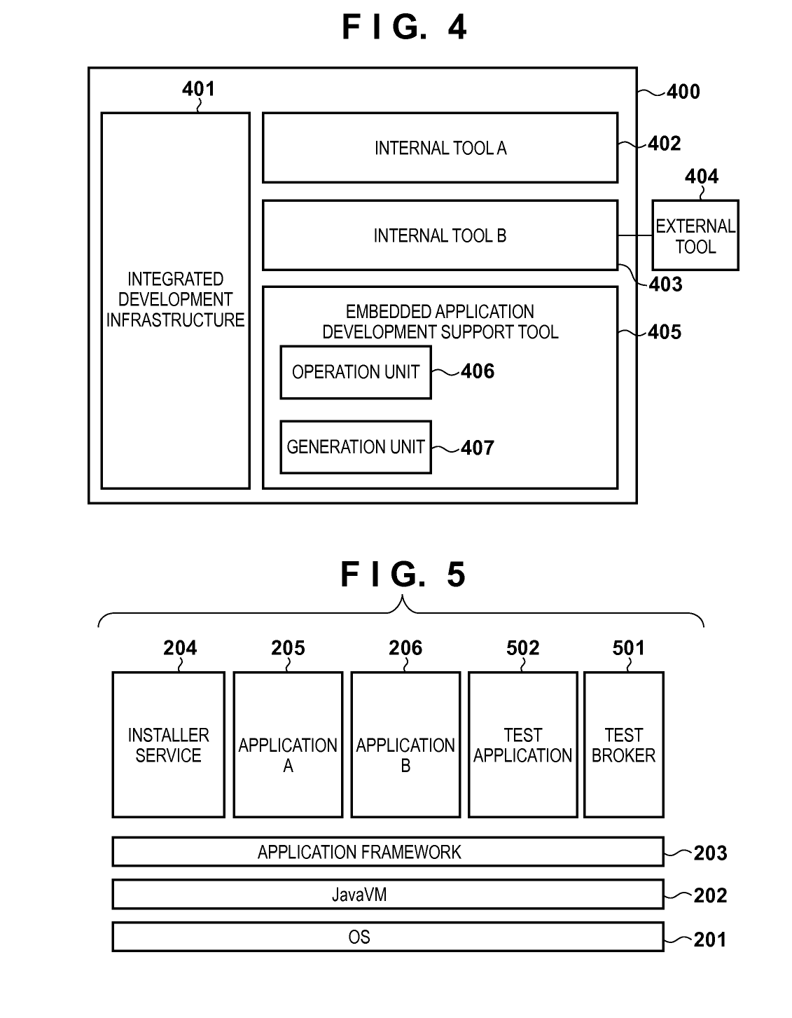

FIG. 4 is a block diagram showing the software arrangement of an integrated development environment system 400 as an example of an integrated development system according to the present invention. In the embodiment, the integrated development environment system 400 is built on the development PC 300. The integrated development environment system 400 includes an integrated development infrastructure 401, an internal tool A 402 which is used by the integrated development infrastructure 401, and an internal tool B 403 which cooperates with an external tool B 404. Further, the integrated development environment system 400 includes an embedded application development support tool 405 at the same rank as those of the internal tools.

The integrated development environment system 400 can use, for example, Eclipse®, but is not limited to this. Note that Eclipse® is an open source integrated software development environment, and is a common platform for software development. Eclipse® provides various functions using two types of tools. The two types of tools are an internal tool which is registered and provided as a plug-in in Eclipse®, and an external tool which does not exist in Eclipse®, such as a debugger or compiler provided by Windows®, UNIX®, or the like.

The integrated development infrastructure 401 includes interfaces for managing an application under development, and making respective tools cooperate with each other. An example of the external tool is JDK (Java Development Kit) used for Java compiling and debugging.

An internal tool can use the function of an external tool via an interface provided by the integrated development infrastructure 401. In the embodiment, JDK has already been set as an external tool by the developer in the integrated development environment system 400, and can be used from an internal tool via the integrated development infrastructure 401. Note that the arrangement of the external and external tools in the integrated development environment system 400 shown in FIG. 4 is merely an example, and the present invention is not limited to this.

The embedded application development support tool 405 has application generation and test support functions executable in an embedded device such as an image forming apparatus. An operation unit 406 has a function of installing an application under development into an embedded device or corresponding simulator. In addition, the operation unit 406 has start, stop, and debug functions for applications running on an embedded device and an embedded device-specific simulator. A generation unit 407 has a function of generating an application.

[Software Arrangement of Image Forming Apparatus in Which Test Application Is Installed]

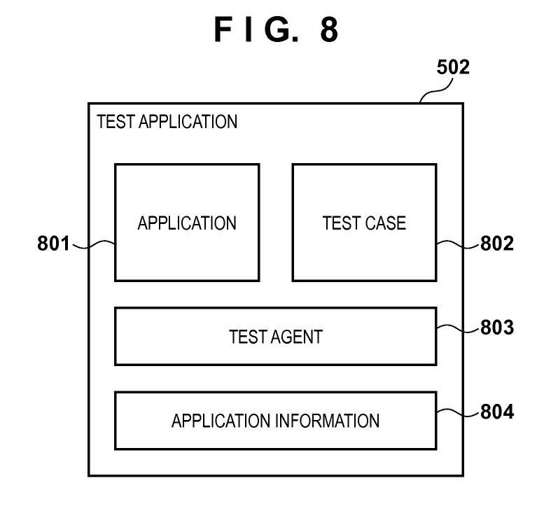

FIG. 5 is a block diagram showing the software of the image forming apparatus 1 when performing a test using the integrated development environment system 400. A test can be performed using the integrated development environment by installing a test broker 501 into the image forming apparatus 1 in the state of FIG. 2 via the installer service 204 by the application developer. The test broker 501 is a module which receives a test application 502 from the development PC 300 to execute a test, sends the test result to the development PC 300, and uninstalls the test application 502 upon the completion of the test. The test application 502 is an application for a test which is configured by combining an application developed by the user and a program for a test into one. The detailed arrangement of the test application 502 will be described later with reference to FIG. 8.

[Generation Unit]

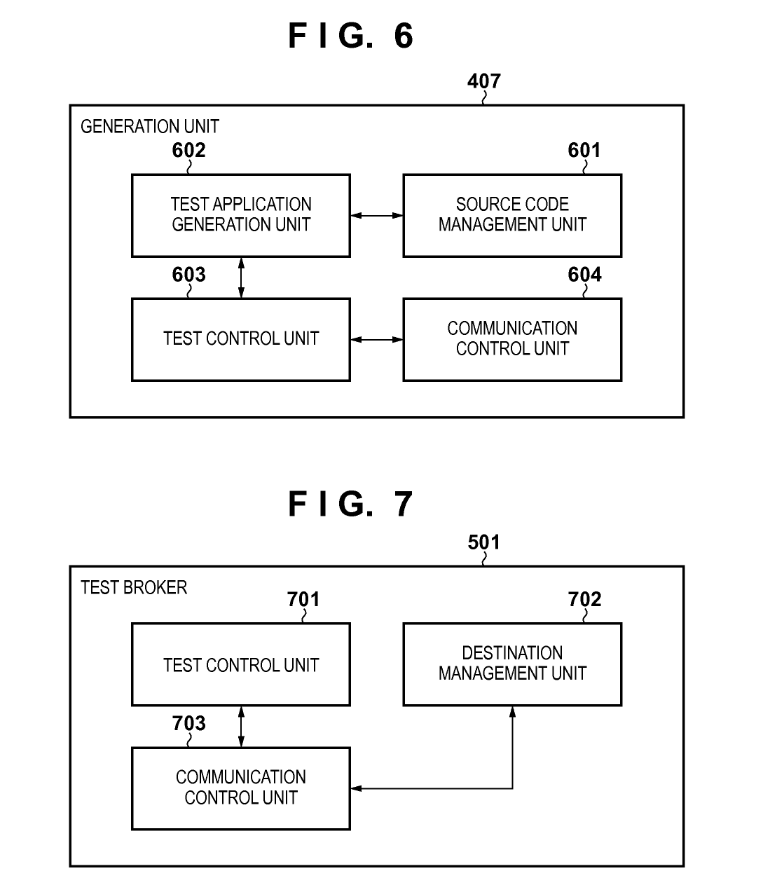

FIG. 6 is a block diagram showing more detailed software of the generation unit 407 included in the embedded application development support tool 405 when performing a test using the integrated development environment system 400. A source code management unit 601 manages the source codes of an application and those of a test case. A test application generation unit 602 compiles source codes managed by the source code management unit 601, generating an application file installable in the image forming apparatus 1. A test control unit 603 receives, via a communication control unit 604 and a test agent 803 contained in the test application 502, the execution instruction and result of a test case 802 in the test application 502 installed in the image forming apparatus 1.

[Test Broker]

FIG. 7 is a block diagram showing the software of the test broker 501 in FIG. 5. A test control unit 701 controls, for example, installation, start, stop, uninstallation, and test case execution of the test application 502, and sends a test result to the integrated development environment system 400. A destination management unit 702 manages connection with the development PC 300 serving as a destination. A communication control unit 703 controls communication with the development PC 300, and sends/receives various data.

[Test Application]

FIG. 8 is a block diagram showing the test application 502 in FIG. 5. The test application 502 includes an application 801, the test case 802, the test agent 803, and application information 804. The application 801 is the entity of an application developed by the developer. The application 801 runs on the image forming apparatus 1, provides an authentication function to the user, and provides functions using a scanner and printer. The application 801 is an application (application program) which is newly registered in the image forming apparatus 1 and provides functions to the user and the like, similar to the application A 205 and application B 206 shown in FIG. 2.

The test case 802 is a program for testing the application 801. The test case 802 describes a test program for executing a function implemented in the application 801 and testing the operation. The test agent 803 executes the test case 802 upon receiving an instruction from the test broker 501. That is, the test agent 803 is a test agent program which issues, for example, a command to start execution of the test case 802. The application information 804 contains the identification ID, application name, and version information of an application contained in the test application 502.

Upon receiving an instruction from the test broker 501 to start execution of the test case 802, the test agent 803 may further issue an instruction to the agent of the image forming apparatus 1 to start execution of the test case 802.

[UI Arrangement]

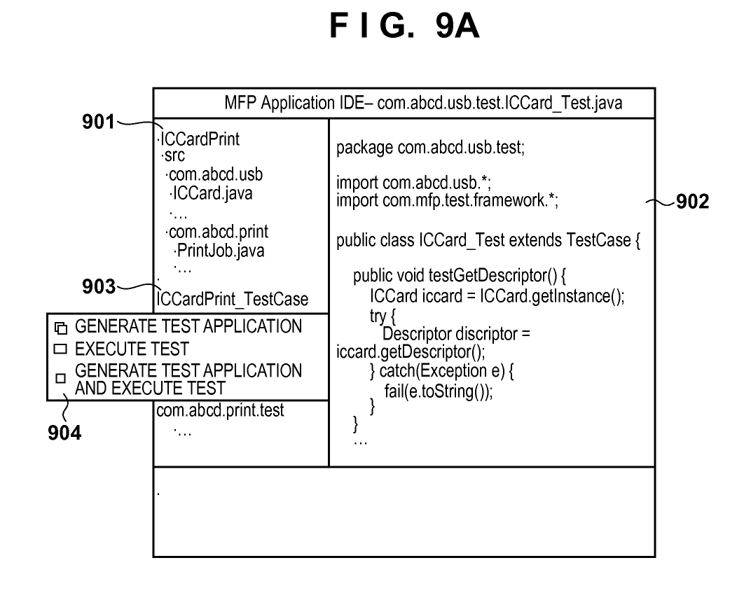

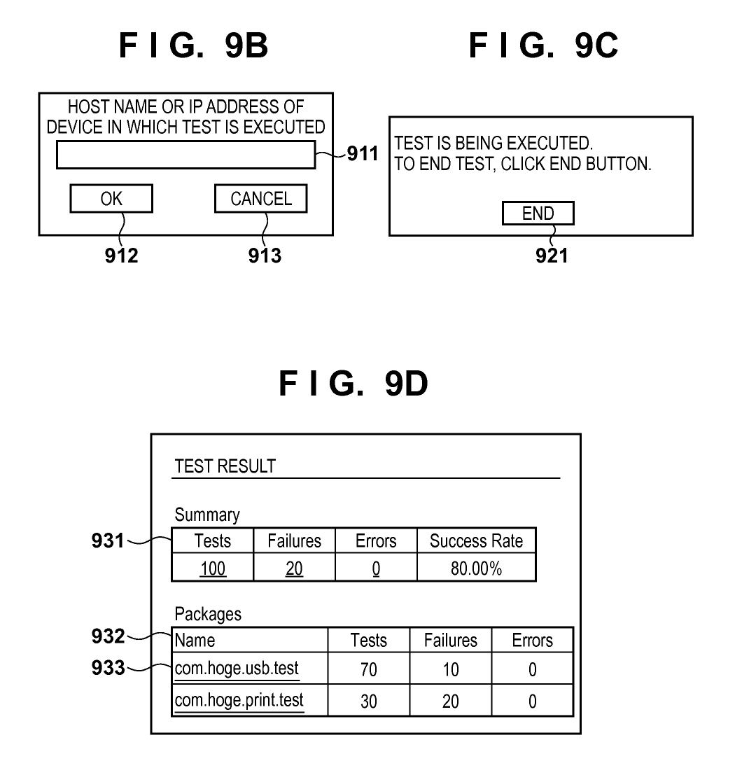

FIGS. 9A, 9B, 9C, and 9D are views each exemplifying the UI of the integrated development environment system 400. FIG. 9A exemplifies a program generation screen in the integrated development environment system 400.

A project display region 901 is a region where information about a project under development in the integrated development environment is displayed. The project display region 901 displays a list of classes and files contained in an application under development in a hierarchical structure. A source display region 902 displays the source codes of a class selected in the project display region. The application developer edits source codes displayed in the source display region 902 to generate the source codes of an application he wants. This corresponds to the application 801 in FIG. 8.

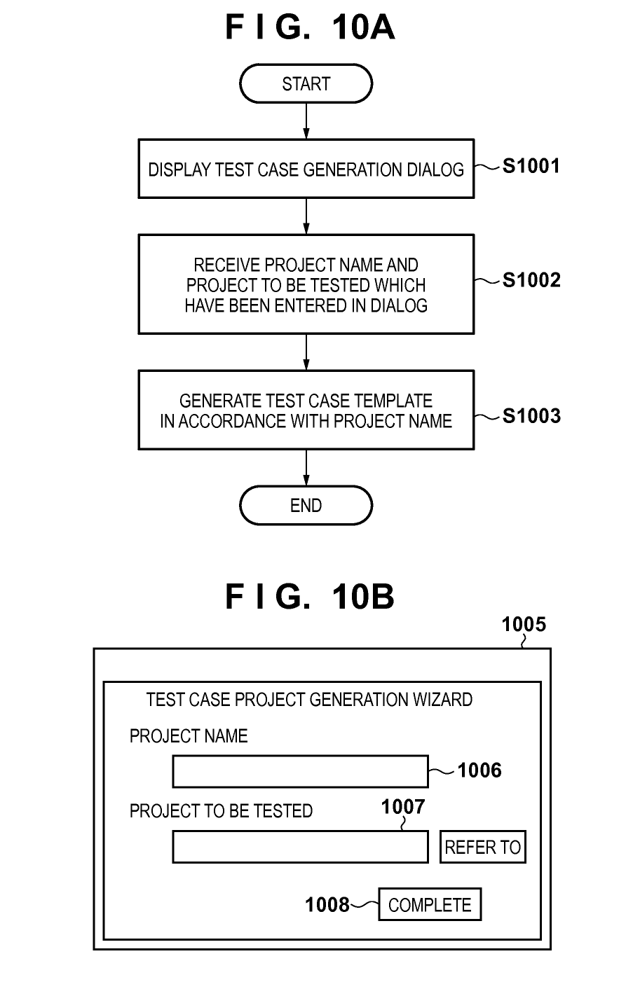

A test case project 903 displayed in the project display region 901 is a test case corresponding to an application (ICCardPrint project) under development. This corresponds to the test case 802 in FIG. 8. A sequence to generate the test case project 903 will be described later with reference to FIGS. 10A and 10B.

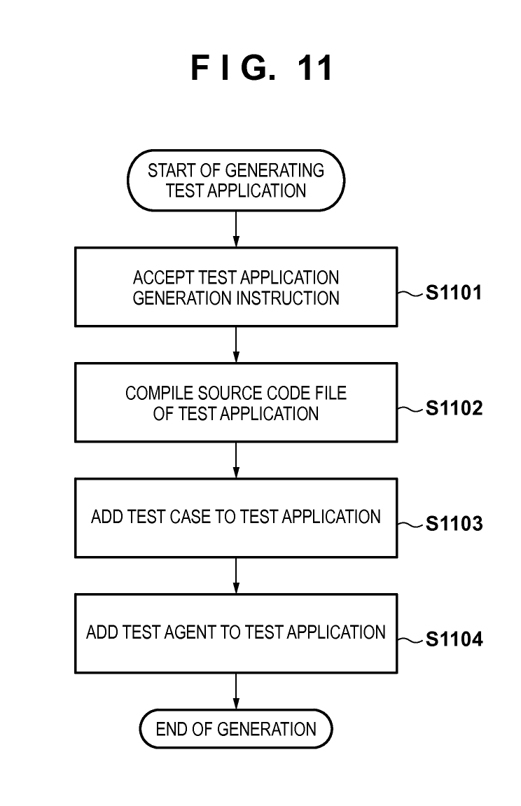

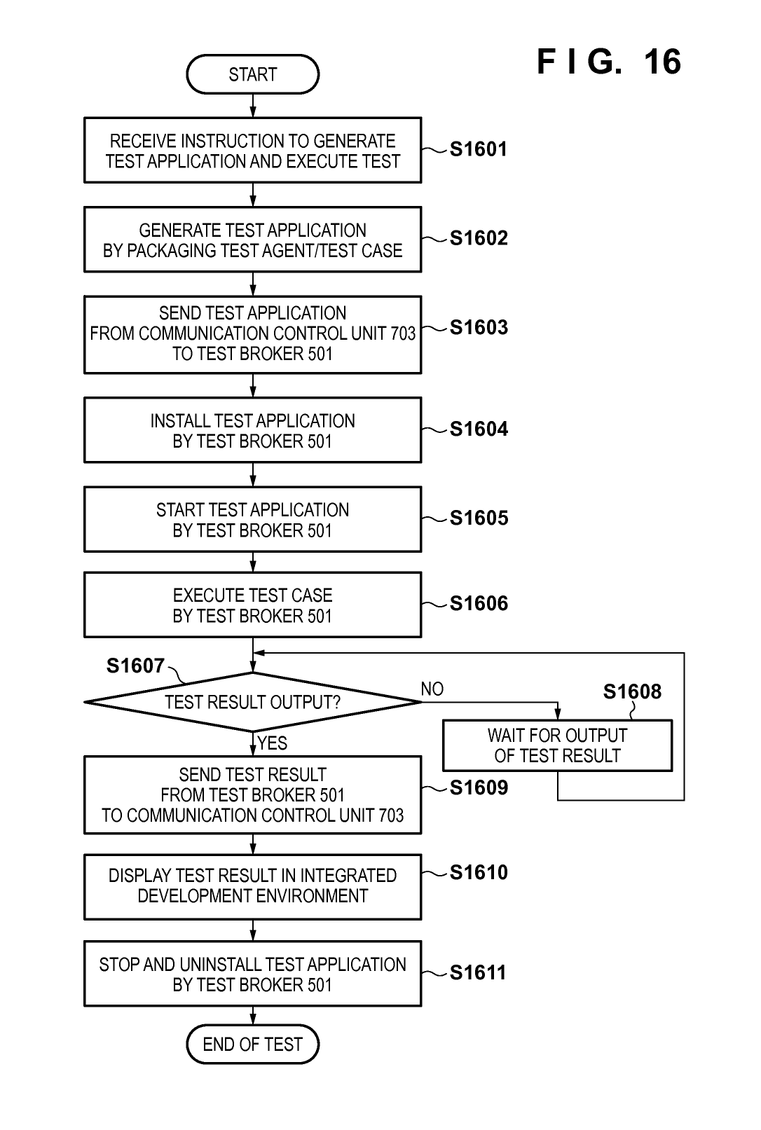

In the embodiment, the program generation screen provides a menu 904 capable of selecting an instruction when generating a test application. The menu 904 is configured to select one of three instructions “generate a test application”, “execute a test”, and “generate a test application and execute a test”. The instruction “generate a test application” generates the test application 502 containing the test case 802. A processing sequence when generation of a test application is designated will be described with reference to FIG. 11. The instruction “execute a test” executes the test case 802 contained in the test application 502 installed in the image forming apparatus 1. A processing sequence when execution of a test is designated will be described with reference to FIG. 14. The instruction “generate a test application and execute a test” executes both of these processes. A processing sequence when this instruction is selected will be described with reference to FIG. 16.

[Test Case Generation Sequence]

A sequence to generate the test case project 903 by the test application generation unit 602 will be explained with reference to FIGS. 10A and 10B. Note that this processing sequence is implemented by reading out a program stored in the HDD 304 serving as a storage unit and executing it by the CPU 301 of the development PC 300.

FIG. 10B shows a dialog 1005 displayed when newly generating the project of the test case 802. The dialog 1005 includes an entry field for designating a project name 1006 of a test case project, and a field 1007 for designating a project to undergo a test case. After the end of entry, the user closes the dialog 1005 by pressing a complete button 1008.

A sequence to generate a test case project will be explained with reference to FIG. 10A. When the user designates new generation of a test case project from the program generation screen of the integrated development environment system 400, the test application generation unit 602 displays the test case generation dialog 1005 shown in FIG. 10B on the development PC 300. In step S1002, the test application generation unit 602 receives a project name and a project to be tested which have been entered to the dialog 1005. In step S1003, the test application generation unit 602 generates a test case project template in accordance with the project name received in step S1002. The process then ends.

[Test Application Generation Sequence]

FIG. 11 is a flowchart showing processing by the generation unit 407 to generate the test application 502 as shown in FIG. 8 when the user selects “generate a test application” from the menu 904 of the program generation screen shown in FIG. 9A. Note that this processing sequence is implemented by reading out a program stored in the HDD 304 serving as a storage unit and executing it by the CPU 301 of the development PC 300.

To generate the test application 502, the application developer selects, on the program generation screen shown in FIG. 9A, an application project (corresponding to the application 801 in FIG. 8) which has been generated using the integrated development environment system 400. Further, the developer selects a test case project (test case project 903 in FIG. 9A) which has been generated in correspondence with the application project, and then selects “generate a test application” from the menu 904 displayed by a right click. In response to the operation by the developer, the generation unit 407 starts generating the test application 502.

In step S1101, the generation unit 407 accepts an instruction to generate the test application 502. In step S1102, the generation unit 407 compiles the source code file of the test application 502. In step S1103, the generation unit 407 adds the test case 802 to the test application 502. In step S1104, the generation unit 407 adds the test agent 803 to the test application 502, generating the test application 502.

After that, the process ends.

[Install Sequence]

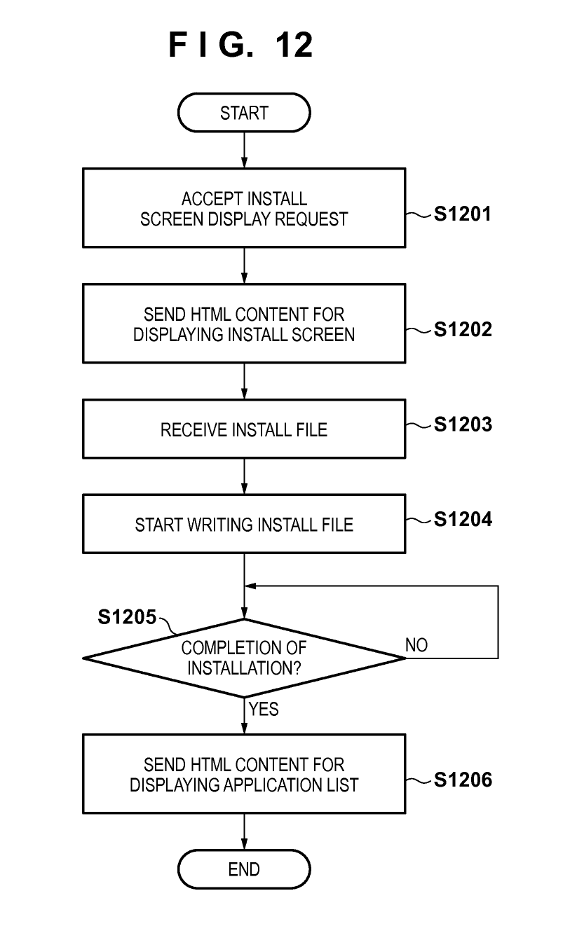

A sequence to install the generated test application 502 in the image forming apparatus 1 will be explained with reference to FIG. 12. FIG. 12 is a flowchart showing processing by the installer service 204 when installing the generated test application 502 in the image forming apparatus 1. Note that this processing sequence is implemented by reading out the program of the installer service 204 stored in the HDD 104 serving as a storage unit and executing it by the CPU 101 of the image forming apparatus 1.

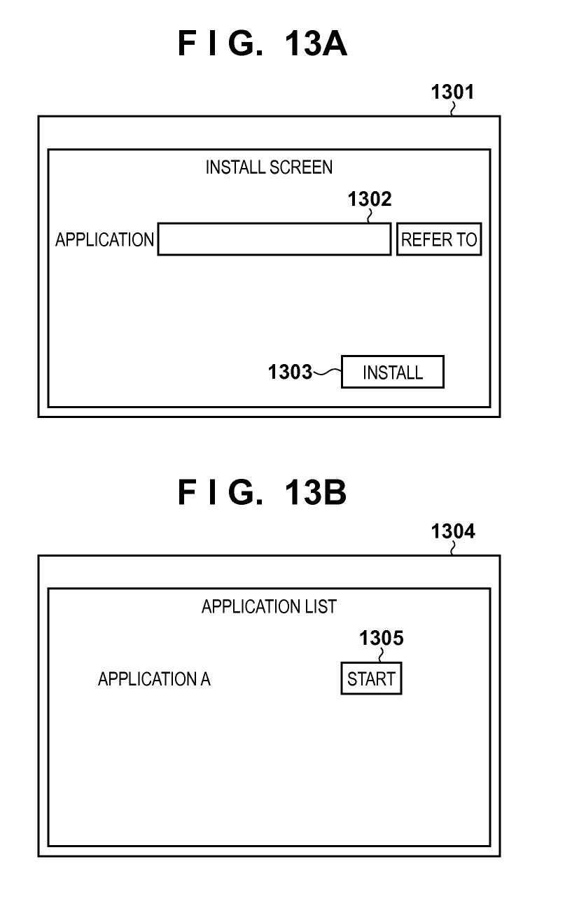

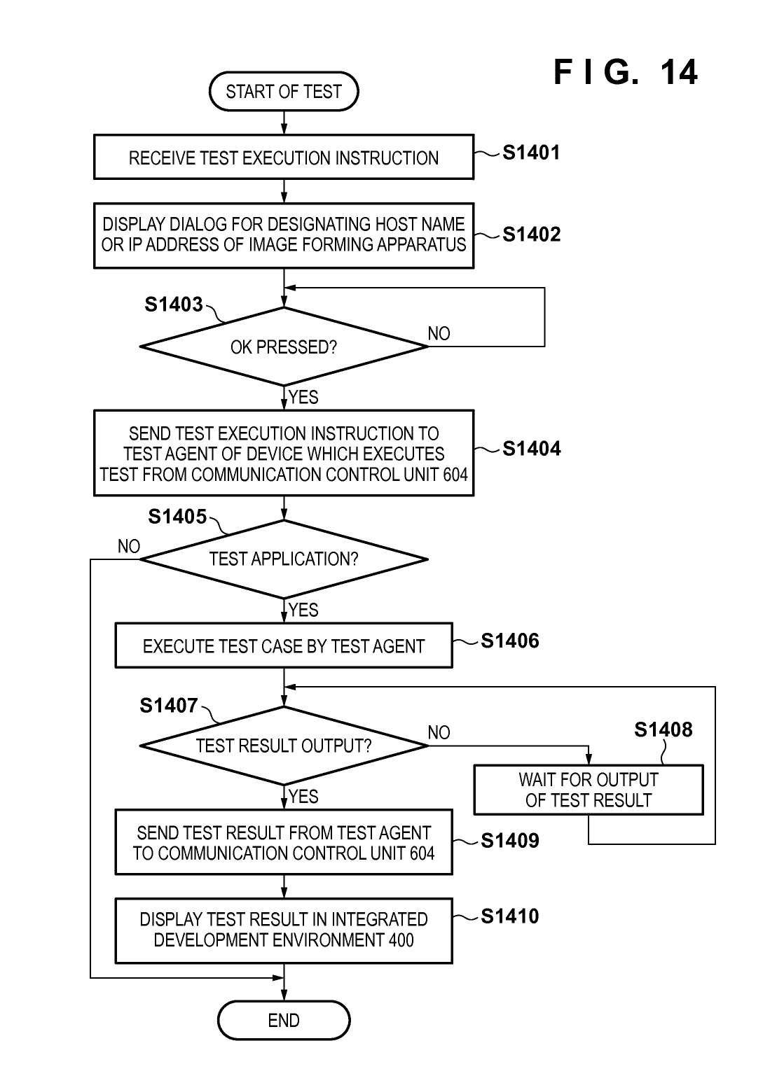

The user installs the test application 502 using the installer service 204 of the image forming apparatus 1. More specifically, the user enters the URL (Uniform Resource Locator) of the installer service 204 using the WEB browser of an apparatus (for example, the development PC 300) connected to the image forming apparatus 1 via a network. Then, the user accesses an install screen (FIG. 13A) provided by the installer service 204. The URL is, for example, “http://ipaddress/install”.

In accordance with an instruction from the user, the installer service 204 receives an install screen display request in step S1201. In step S1202, the installer service 204 sends an HTML content for displaying an install screen, to the requesting PC in response to the display request. The user designates an application to be installed in a field 1302 of FIG. 13A. At this time, the user may directly designate a path in which an application is saved, or select a file with a reference button. When the user presses an install button 1303, the installer service 204 receives an install file in step S1203. In step S1204, the installer service 204 starts writing the install file. In step S1205, after the start of writing the install file, the installer service 204 determines whether the installation has been completed. If the installation has not been completed (NO in step S1205), the process waits till the completion of the installation. If the installation has been completed (YES in step S1205), the process advances to step S1206, and the installer service 204 sends, to the requesting PC, an HTML content for displaying a list 1304 of installed applications (FIG. 13B). The process then ends.

When the user presses a start button 1305 in the list 1304, the installed application is activated and can provide a service.

[Test Case Execution Sequence]

A UI when executing a test case will be explained. If the user designates “execute a test” from the menu 904 on the program generation screen after the installer service 204 installs a generated test application in the image forming apparatus 1, a dialog in FIG. 9B appears.

In FIG. 9B, a text field 911 is a field for entering the host name or IP address of the image forming apparatus in which a test is executed. An OK button 912 is a button for designating execution of a test. A cancel button 913 is a button for canceling execution of a test. When the user presses the OK button 912, the test starts, and a dialog in FIG. 9C appears. Upon completion of executing all test cases, the dialog in FIG. 9C automatically disappears. When the user wants to interrupt a test in progress, he can end the test by pressing an end button 921.

FIG. 9D exemplifies a screen which appears when a test ends or is interrupted. This screen appears after notifying the result of a test executed by the image forming apparatus. A test result summary display region 931 displays the number of executed test cases, the number of test failures, the number of errors, and the test success rate. A package information display region 932 displays a list of test results for each package of an application. By clicking a package name 933, detailed results can be displayed for each test case.

The arrangements of the respective screens shown in FIGS. 9A to 9D are merely examples, and the present invention is not limited to them. For example, the arrangement of the respective regions in the program generation screen in FIG. 9A may be changed in accordance with the user's preference.

FIG. 14 is a flowchart showing a sequence when the communication control unit 604 executes the test case 802 of the test application 502 via the test agent 803 of the test application 502. Note that this processing sequence is implemented by reading out a program stored in the HDD 304 serving as a storage unit and executing it by the CPU 301 of the development PC 300.

The user selects a test case project (project 903 in FIG. 9A) generated in correspondence with the application 801 of the test application 502, and selects “execute a test” from the menu (menu 904 in FIG. 9A) displayed by a right click. In step S1401, the test control unit 603 accepts a test execution instruction. In step S1402, the test control unit 603 displays, on the development PC 300, the dialog (FIG. 9B) for entering the host name or IP address of the image forming apparatus 1. In step S1403, the test control unit 603 determines whether the user has pressed the OK button 912 after he enters the host name or IP address of the image forming apparatus 1. If the test control unit 603 determines that the user has pressed the OK button 912 (YES in step S1403), the process advances to step S1404. If the test control unit 603 determines that the user has not pressed the OK button 912 (NO in step S1403), the test control unit 603 waits until the user presses the OK button 912.

In step S1404, the test control unit 603 sends a test execution instruction via the communication control unit 604 to the test agent 803 of the device in which the test case 802 is executed. If no response is sent back from the test application 502 and the presence of the test application 502 cannot be confirmed in the image forming apparatus 1 in step S1405 (NO in step S1405), the processing sequence ends.

If the presence of the test application 502 is confirmed (YES in step S1405), the test agent 803 executes the test case 802 in step S1406. In step S1407, the test control unit 603 determines whether all executed test cases have ended and the test results have been output. If no test result has been output (NO in step S1407), the test control unit 603 waits for output of the test results in step S1408, and the process returns to step S1407. If the test control unit 603 determines that the test results have been output (YES in step S1407), the process advances to step S1409. In step S1409, the test control unit 701 of the test broker 501 sends the results of the tests executed by the test agent 803 to the communication control unit 604 of the integrated development environment system 400 via the communication control unit 703. In step S1410, the test control unit 603 displays the received test results in the integrated development environment system 400. Thereafter, the process ends.

[Communication Sequence]

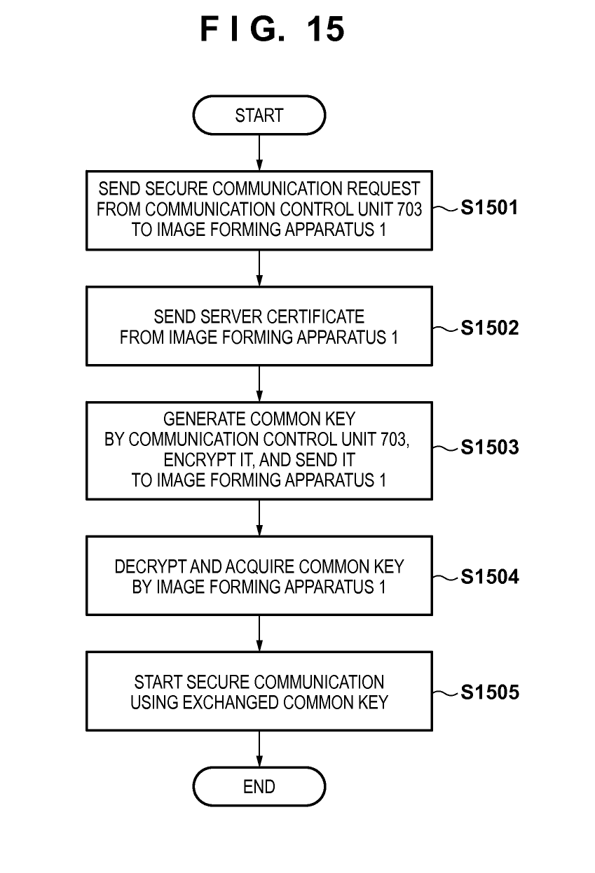

A communication sequence to execute the test case 802 and send a test result more securely will be explained with reference to FIG. 15. An authentication method to be described in the embodiment complies with a general SSL (Secure Socket Layer) method. Note that this processing sequence is implemented by reading out programs stored in the HDDs serving as storage units and executing them by the CPUs of the image forming apparatus 1 and development PC 300.

The example in FIG. 15 shows a sequence to establish secure communication from the communication control unit 703 of the integrated development environment system 400 to the image forming apparatus 1. Implementing the secure communication can prevent peeps of information about an API called by the user and a test result. A description of a case in which the test agent 803 of the test application 502 sends a test result will be omitted. However, this can be achieved by reversing the relationship between the communication source and the communication destination in the example of FIG. 15.

In step S1501, the communication control unit 703 of the integrated development environment system 400 sends a secure communication request to the image forming apparatus 1. Upon receiving the request, in step S1502, the image forming apparatus 1 sends a server certificate necessary for communication to the communication control unit 703 which has sent the request. In step S1503, upon receiving the server certificate, the communication control unit 703 generates a common key based on a server ID contained in the server certificate, encrypts the generated common key using a public key, and sends it to the image forming apparatus 1. In step S1504, the image forming apparatus 1 decrypts the encrypted common key using a private key paired with the public key, acquiring the common key. In step S1505, secure communication starts between the image forming apparatus 1 and the development PC 300 using the common key acquired by both of them.

FIG. 15 shows processing up to the start of general secure communication. However, the secure communication method in the present invention is not limited to this sequence, and can use another authentication method.

[Processing Sequence of Test Application Installation and Test Execution]

FIG. 16 is a flowchart showing a sequence to install the test application 502 generated by the integrated development environment system 400 in the image forming apparatus 1 from the communication control unit 703 via the communication control unit 703 of the test broker 501, and execute a test. Note that this processing sequence is implemented by reading out programs stored in the HDDs serving as storage units and executing them by the CPUs of the image forming apparatus 1 and development PC 300.

The user selects the project of the application 801 of the test application 502 generated using the integrated development environment system 400, and the project (project 903 in FIG. 9A) of a test case generated in correspondence with the application 801. Further, the user selects “generate a test application and execute a test” from the menu 904 of FIG. 9A.

In accordance with a user instruction, in step S1601, the generation unit 407 accepts an instruction to generate a test application and execute a test. In step S1602, the generation unit 407 generates the test application 502 in which the test case 802 is packaged in the selected project of the test application 502. In step S1603, the communication control unit 703 sends the test application 502 generated in step S1602 to the communication control unit 703 of the test broker 501.

In step S1604, the test broker 501 installs the received test application 502 in the image forming apparatus 1 via the installer service 204. In step S1605, the test broker 501 starts the installed test application 502.

In step S1606, the test broker 501 executes the test case 802 of the test application 502. In step S1607, the test broker 501 determines whether the test case has ended and the test result has been output. If no test result has been output yet (NO in step S1607), the process waits for output of the test result in step S1608, and returns to step S1607. If the test broker 501 determines in step S1607 that the test result has been output (YES in step S1607), the process advances to step S1609.

In step S1609, the test broker 501 sends the output test result to the communication control unit 703 of the integrated development environment. In step S1610, the communication control unit 703 displays the received test result. In step S1611, the test broker 501 stops the test application installed for test execution, and uninstalls it via the installer service 204. Then, the process ends.

As described above, by generating an application containing an application serving as a test case used for a unit test, an externally installed unit test bundle can be executed without changing the settings of the application. Further, an operation check test for the application can be executed even in an environment where it is difficult to alter the application, such as the environment of a user who purchased the application. Secure communication can be implemented by establishing communication after authentication processing such as SSL between the image forming apparatus and the PC. Hence, an instruction to a test application and the execution result can be sent/received securely.

### Second Embodiment

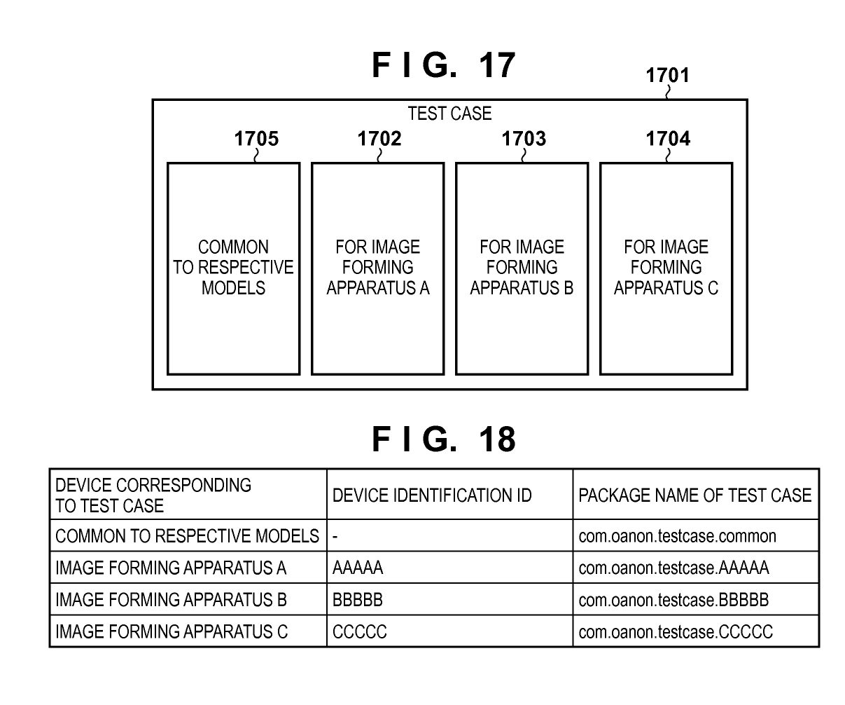

The second embodiment according to the present invention will be described in detail below with reference to the accompanying drawings. A more detailed arrangement for a test case contained in a test application 502 in FIG. 8 will be explained with reference to FIG. 17.

A test case 1701 shown in FIG. 17 is divided for respective models of image forming apparatuses in which the test application 502 runs. More specifically, the test case is divided for respective models into a test case 1702 which runs on image forming apparatus A, a test case 1703 which runs on image forming apparatus B, and a test case 1704 which runs on image forming apparatus C. As a model-independent common test case, there is a test case common to respective models, such as a test case 1705.

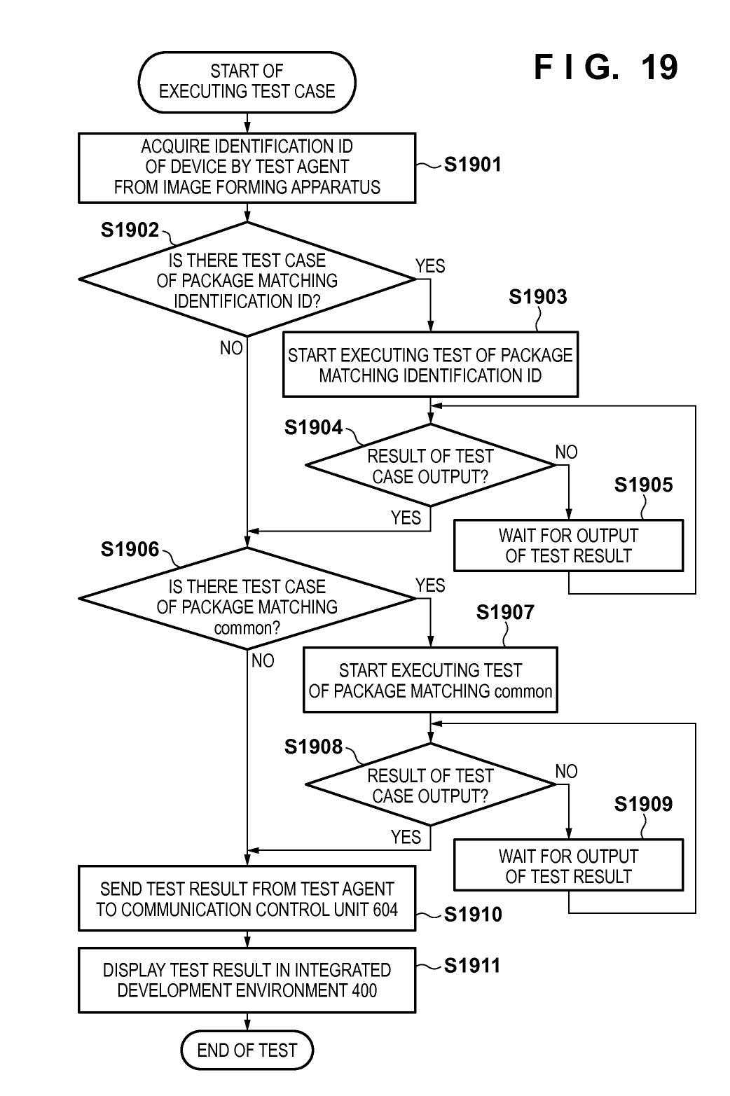

FIG. 18 exemplifies the package names of the divided test cases. An identification ID is assigned to each image forming apparatus as identification information for uniquely identifying it. The name of a package which runs on image forming apparatus A is a package name “com.oanon.testcase.AAAAA” containing an identification ID “AAAAA” representing image forming apparatus A. Similarly, the name of a package which runs on image forming apparatus B is “com.oanon.testcase.BBBBB”. The name of a package which runs on image forming apparatus C is “com.oanon.testcase.CCCCC”. The test case 1705 common to respective models shown in FIG. 17 has a package name “com.oanon.testcase.common”.

[Test Execution Sequence]

A sequence to execute a test by a test agent 803 shown in FIG. 8 in the test case arrangement shown in FIG. 18 will be explained with reference to FIG. 19. Note that this processing sequence is implemented by reading out programs stored in HDDs serving as storage units and executing them by the CPUs of an image forming apparatus 1 and development PC 300.

After the start of executing a test case by the test agent 803, the test agent 803 acquires the identification ID of a device from the image forming apparatus 1 in step S1901. In step S1902, the test agent 803 determines whether the identification ID acquired in step S1901 matches the package of the test case. If the identification ID matches the package of the test case (YES in step S1902), the process advances to step S1903; if they do not match each other (NO in step S1902), to step S1906. In step S1903, the test agent 803 executes the test of the package matching the identification ID. In step S1904, the test agent 803 determines whether all executed test cases have ended and the test results have been output. If no test result has been output (NO in step S1904), the test agent 803 waits for output of the test results in step S1905, and the process returns to step S1904. If the test agent 803 determines that the test results have been output (YES in step S1904), the process advances to step S1906.

In step S1906, the test agent 803 determines whether the package of the test case matches “common”. If the package matches “common” (YES in step S1906), the process advances to step S1907; if they do not match each other (NO in step S1906), to step S1910. In step S1907, the test agent 803 executes a test for the common package.

In step S1908, the test agent 803 determines whether all executed test cases have ended and the test results have been output. If no test result has been output (NO in step S1908), the test agent 803 waits for output of the test results in step S1909, and the process returns to step S1908. If the test agent 803 determines that the test results of the common package have been output (YES in step S1908), the process advances to step S1910.

In step S1910, the test agent 803 sends the test results to a communication control unit 604 of an integrated development environment system 400 via a test broker 501. In step S1911, the received test results are displayed in the integrated development environment system 400. The process then ends.

Note that a test execution instruction and sending of a test result are executed after establishing secure communication, as described in the first embodiment.

In addition to the effects of the first embodiment, the second embodiment can define a test corresponding to a device type, and execute only the test corresponding to the device. Hence, an unnecessary test and result need not be handled.

In installing a test application when a test case is divided into a plurality of test cases in accordance with device types, it is also possible to acquire a device ID and install only a test case for this device. In this case, test cases which are not installed may be discarded. Since only a minimum number of test cases are provided to the device, unwanted consumption of resources such as a memory in the device can be prevented.

The PC may designate a test case to be executed among a plurality of test cases. In this case, an instruction to be sent from the PC to the test agent may contain the identification ID of a device.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-206559, filed Sep. 21, 2011, which is hereby incorporated by reference herein in its entirety.

What is claimed is:

1. A system comprising an image forming apparatus capable of installing and executing a provided application, and an information processing apparatus which provides a development environment for the application to be executed by the image forming apparatus,
the information processing apparatus including:
a generation unit configured to generate, upon receiving an instruction to generate an application to be executed in the image forming apparatus, an application containing an application program for implementing a function of the application, a test program for testing a function provided by the application, and a test agent program for issuing a command to start execution of the test program in accordance with an instruction from the information processing apparatus;
a send unit configured to send the application generated by said generation unit to the image forming apparatus; and
an instruction unit configured to issue, upon receiving an instruction to start the test program, an instruction via the test agent program to start execution of the test program contained in the application installed in the image forming apparatus, and
the image forming apparatus including:
an installation unit configured to install the application upon receiving an instruction to install the application generated by said generation unit; and
a start unit configured to start execution of the test program in accordance with the command issued from the test agent program upon accepting the instruction from said instruction unit via the test agent program to start execution of the test program.

2. The system according to claim 1, wherein
the image forming apparatus further includes a notification unit configured to notifies the information processing apparatus of a result of a test of the function of the application by the test program, and
the information processing apparatus further includes a display unit configured to display the result of the test notified from the image forming apparatus.

3. The system according to claim 2, wherein
each of the information processing apparatus and the image forming apparatus includes a communication unit configured to establish communication using a certificate between the information processing apparatus and the image forming apparatus, and
said instruction unit sends an instruction via the communication established by said communication unit.

4. The system according to claim 3, wherein said communication unit notifies the result of the test to the information processing apparatus via the communication established by said communication unit.

5. The system according to claim 1, wherein the generated application contains a plurality of test programs corresponding to types of image forming apparatuses.

6. The system according to claim 5, wherein said installation unit installs a test program corresponding to the image forming apparatus out of the plurality of test programs contained in the generated application.

7. The system according to claim 5, further comprising:
an acquisition unit configured to acquire identification information representing a type of an image forming apparatus in which the application runs; and
a selection unit configured to select a test program corresponding to the image forming apparatus represented by the acquired identification information from the plurality of test programs contained in the generated application,
wherein said start unit starts execution of the test program selected by said selection unit upon accepting the instruction from said instruction unit to start execution of the test program.

8. The system according to claim 5, wherein said instruction unit designates a test program to be executed out of the plurality of test programs contained in the generated application.

9. An image forming apparatus capable of installing and executing an externally provided application, comprising:
a reception unit configured to receive an application containing an application program for implementing a function of the application, a test program for testing a function provided by the application, and a test agent program for issuing a command to start execution of the test program in accordance with an external instruction;
an installation unit configured to install the received application; and
a start unit configured to start execution of the test program in accordance with the command issued from the test agent program upon accepting the instruction via the test agent program to start execution of the test program.

10. An information processing apparatus which provides a development environment for an application to be executed by an image forming apparatus capable of adding and executing an externally provided application, comprising:
a generation unit configured to generate, upon receiving an instruction to generate an application to be executed in the image forming apparatus, an application containing an application program for implementing a function of the application, a test program for testing a function provided by the application, and a test agent program for issuing a command to start execution of the test program in accordance with an instruction from the information processing apparatus;
a send unit configured to send the application generated by said generation unit to the image forming apparatus; and
an instruction unit configured to issue, upon receiving an instruction to start the test program, an instruction via the test agent program to start execution of the test program contained in the application installed in the image forming apparatus.

11. A method of controlling an image forming apparatus capable of installing and executing an externally provided application, comprising the steps of:
receiving an application containing an application program for implementing a function of the application, a test program for testing a function provided by the application, and a test agent program for issuing a command to start execution of the test program in accordance with an external instruction;
installing the received application; and
starting execution of the test program in accordance with the command issued from the test agent program upon accepting the instruction via the test agent program to start execution of the test program.

12. A method of controlling an information processing apparatus which provides a development environment for an application to be executed by an image forming apparatus capable of adding and executing an externally provided application, comprising the steps of:
generating, upon receiving an instruction to generate an application to be executed in the image forming apparatus, an application containing an application program for implementing a function of the application, a test program for testing a function provided by the application, and a test agent program for issuing a command to start execution of the test program in accordance with an instruction from the information processing apparatus;
sending the application generated in the generation step to the image forming apparatus; and
issuing, upon receiving an instruction to start the test program, an instruction via the test agent program to start execution of the test program contained in the application installed in the image forming apparatus.

13. A non-transitory computer-readable medium storing a program for causing a computer to function as
a reception unit configured to receive an application containing an application program for implementing a function of the application, a test program for testing a function provided by the application, and a test agent program for issuing a command to start execution of the test program in accordance with an instruction from the computer,
an installation unit configured to install the received application, and
a start unit configured to start execution of the test program in accordance with the command issued from the test agent program upon accepting the instruction via the test agent program to start execution of the test program.

14. A non-transitory computer-readable medium storing a program for causing a computer to function as
a generation unit configured to generate, upon receiving an instruction to generate an application to be executed in an image forming apparatus capable of adding and executing an externally provided application, an application containing an application program for implementing a function of the application, a test program for testing a function provided by the application, and a test agent program for issuing a command to start execution of the test program in accordance with an external instruction,
a send unit configured to send the application generated by said generation unit to the image forming apparatus, and
an instruction unit configured to issue, upon receiving an instruction to start the test program, an instruction via the test agent program to start execution of the test program contained in the application installed in the image forming apparatus.
